(19) United States
(12) Patent Application Publication
(10) Pub. No.: US 2021/0209487 A1
(43) Pub. Date: Jul. 8, 2021

(54) ELECTRONIC APPARATUS AND METHOD FOR OPERATING THE SAME

(71) Applicant: LG ELECTRONICS INC., Seoul (KR)

(72) Inventors: Won-Ho SHIN, Seoul (KR); Ji Chan Maeng, Seoul (KR)

(73) Assignee: LG ELECTRONICS INC., Seoul (KR)

(21) Appl. No.: 17/009,281

(22) Filed: Sep. 1, 2020

(30) Foreign Application Priority Data
Jan. 3, 2020 (KR) 10-2020-0000762

(51) Int. Cl. G06N 5/04; G10L 15/22; G06N 3/08

(52) U.S. Cl. CPC G06N 5/04; G06N 3/08; G10L 15/22

(57) ABSTRACT

Disclosed is an electric apparatus. The electronic apparatus includes a memory and a processor. The electronic apparatus may execute an artificial intelligence (AI) algorithm and/or a machine learning algorithm and communicate with other electronic devices in a 5G communication environment. As a result, the electronic apparatus may provide a user with convenience.

### CROSS-REFERENCE TO RELATED APPLICATION(S)

Pursuant to 35 U.S.C. § 119(a), this application claims the benefit of earlier filing date and right of priority to Korean Patent Application No. 10-2020-0000762, filed on Jan. 3, 2020, the contents of which are hereby incorporated by reference herein in its entirety.

### BACKGROUND

### 1. Technical Field

The present disclosure relates to an electronic apparatus for generating and providing an answer to a question and additional questions, and a method for operating same.

### 2. Description of Related Art

Due to development of technology, various services which apply voice recognition, natural language interpretation, etc. in Information communication Technology (ICT) fields have been introduced recently. Of these services, a computer program that performs a specific operation through conversation with human by voice or text is referred to as a “chatbot.”

While electronic apparatuses equipped with a chatbot in the prior art provide a user with a conversation service, the apparatuses are limited in that the apparatuses may only give partial opinions on limited fields, and are not able to provide diverse user-tailored opinions.

### SUMMARY OF THE INVENTION

Embodiments of the present disclosure are directed to providing an electronic apparatus that provides a user-tailored answer to a user question and a method for operating the same.

Embodiments of the present disclosure are further directed to provide an electronic apparatus that can perform a proactive conversation with a user and a method for operating the same.

The present disclosure is not limited to what has been described above, and other aspects not mentioned herein will be apparent from the following description to one of ordinary skill in the art to which the present disclosure pertains.

According to an embodiment of the present disclosure, provided is an electronic apparatus that gives a predicted interest index to a topic associated with a user, and performs a conversation with the user based on the predicted interest index.

To this end, an electronic apparatus according to an embodiment of the present disclosure includes a memory configured to store information on a topic associated with a user, and a processor coupled to the memory, wherein the processor is configured to determine a predicted interest index of the user on the topic based on event information on the topic, determine a topic to be used in conversation with the user based on the predicted interest index, and generate a question to be provided to the user in the conversation with the user based on the event information on the determined topic

According to another embodiment of the present disclosure, provided is a method for operating an electronic apparatus, in which a new question is generated based on a predicted interest index of a user on a topic.

To this end, a method for operating an electronic apparatus according to an embodiment of the present disclosure includes determining a predicted interest index of a user on a topic based on event information on the topic associated with the user, determining a topic to be used in conversation with the user based on the predicted interest index, and generating a question to be provided to the user in the conversation with the user based on the event information on the determined topic.

Aspects of the present disclosure are not limited what has been disclosed herein above and other aspects can be clearly understood from the following description by those skilled in the art to which the present disclosure pertains.

### Advantageous Effects of Invention

According to embodiments of the present disclosure, an electronic apparatus may facilitate performing a proactive conversation with a user on a topic in which the user is interested by taking account of a predicted interest index of the user.

In addition, the electronic apparatus may enhance user satisfaction as the apparatus provides a proactive conversation tailored to the user.

It should be noted that effects of the present disclosure are not limited to the effects of the present disclosure as mentioned above, and other unmentioned effects of the present disclosure will be clearly understood by those skilled in the art from an embodiment described below.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements, in which:

FIG. 1 is a diagram illustrating a cloud system based on a 5G network according to an embodiment of the present disclosure;

FIG. 2 is a block diagram illustrating components of an electronic apparatus according to an embodiment of the present disclosure;

FIG. 3 is a flow diagram illustrating a method for operating an electronic apparatus according to an embodiment of the present disclosure;

FIG. 4 is a diagram illustrating the method for operating an electronic apparatus according to an embodiment of the present disclosure;

FIG. 5 is a flow diagram illustrating the method for operating an electronic apparatus according to an embodiment of the present disclosure; and

FIG. 6 is a table illustrating information on an exemplary topic.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

Since various embodiments of the present disclosure may utilize techniques relating to artificial intelligence, artificial intelligence will be generally described below.

Artificial Intelligence (AI) refers to a field of studying artificial intelligence or a methodology for creating the same. Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed artificial neurons (nodes) forming a network by a connection of synapses. The ANN may be defined by a connection pattern between neurons on difference layers, a learning process for updating model parameters, and an activation function for generating an output value.

An ANN may include an input layer, an output layer, and may selectively include one or more hidden layers. Each layer includes one or more neurons, and the artificial neural network may include synapses that connect the neurons to one another. In the artificial neural network, each neuron may output a function value of the activation function with respect to input signals inputted through the synapses, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, and initialization function, and the like.

The objective of training an ANN is to determine a model parameter for significantly reducing a loss function. The loss function may be used as an indicator for determining an optimal model parameter in a learning process of an artificial neural network.

Machine learning may be classified into supervised learning, unsupervised learning, and reinforcement learning depending on the learning method.

Supervised learning may refer to a method for training an artificial neural network with training data that has been given a label. In addition, the label may refer to a target answer (or a result value) to be guessed by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

Hereinafter, embodiments disclosed herein will be described in detail with reference to the accompanying drawings, and the same reference numerals are given to the same or similar components and duplicate descriptions thereof will be omitted. In addition, in describing an embodiment disclosed in the present document, if it is determined that a detailed description of a related art incorporated herein unnecessarily obscure the gist of the embodiment, the detailed description thereof will be omitted.

The terminology used herein is used for the purpose of describing particular exemplary embodiments only and is not intended to be limiting. As used herein, the articles “a,” “an,” and “the,” include plural referents unless the context clearly dictates otherwise. The terms “comprise,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or a combination thereof. Furthermore, these terms such as “first,” “second,” and other numerical terms, are used only to distinguish one element from another element. These terms are generally only used to distinguish one element from another.

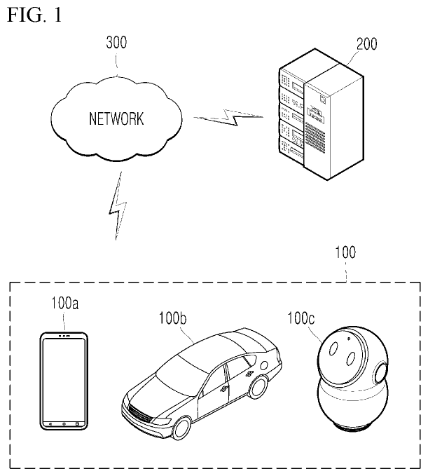

FIG. 1 is a diagram illustrating a cloud system 1000 based on a 5G network according to an embodiment of the present disclosure.

The cloud system 1000 may include an electronic device 100 configured to provide a conversation service, an information providing system 200, and a network 300.

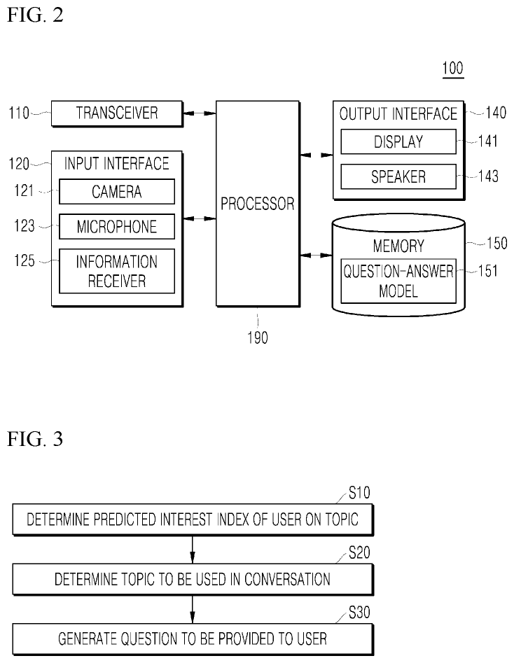

The electronic device 100 may acquire speech of a questioner through a microphone (123 of FIG. 2 mentioned later) to recognize information on the question of the questioner from the inputted voice, or receive the question information through an information receiver (125 of FIG. 2 mentioned later) by text to recognize the question information.

The electronic device 100 may include a chatbot which is a computer program configured to perform a specific operation through a conversation with human by voice or text. The chatbot may contain intrinsic profile information to perform a conversation service.

For example, the electronic device 100 may include a mobile terminal 00a, an autonomous vehicle 100b and a robot 100c. The electronic device 100 may include a communication terminal configured to perform a function of a computing device (not shown). Here, the electronic device 100 may be, but is not limited to, a desktop computer, a smartphone, a laptop computer, a tablet PC, a smart TV, a cellular phone, a personal digital assistant (PDA), a media player, a micro-server, a global positioning system (GPS) device, an electronic book terminal, a digital broadcasting terminal, a navigation device, a kiosk, an MP3 player, a digital camera, an electric home appliance, or any of other mobile or immobile computing devices configured to be manipulated by a user. In addition, the electronic device 100 may be a wearable device having a communication function and a data processing function, such as a watch, glasses, a hair band, or a ring. The electronic device 100 is not limited to the aforementioned disclosure, and a terminal which is capable of web browsing may be used without limitations.

The electronic device 100 may transmit and receive data with the information providing system 200 and various communicable terminals through the network 300. In particular, the electronic device 100 may perform a data communication with the information providing system 200 and the various terminals through the network 300 by using at least one service of Enhanced Mobile Broadband (eMBB), Ultra-reliable and low latency communications (URLLC), or Massive Machine-type communications (mMTC).

The eMBB is a mobile broadband service, and provides, for example, multimedia contents and wireless data access. In addition, more improved mobile services such as a hotspot and a wideband coverage for receiving mobile traffic that are tremendously increasing may be provided through eMBB. Through a hotspot, high-volume traffic may be accommodated in an area where user mobility is low and user density is high. A wide and stable wireless environment and user mobility can be secured by a wideband coverage.

The URLLC service defines requirements that are far more stringent than existing LTE in terms of reliability and transmission delay of data transmission and reception, and corresponds to a 5G service for production process automation in fields such as industrial fields, telemedicine, remote surgery, transportation, safety, and the like.

The mMTC is a service that is not sensitive to transmission delay requiring a relatively small amount of data transmission. The mMT enables a much larger number of terminals, such as sensors, than general mobile cellular phones to be simultaneously connected to a wireless access network. In this case, the price of the communication module of a terminal should be low and a technology improved to increase power efficiency and save power is required to enable operation for several years without replacing or recharging a battery.

The information providing system 200 may provide the electronic device 100 with various services, and access information which is inaccessible from the electronic device 100.

The information providing system 200 may be implemented with a cloud system and include a plurality of servers. The electronic device 100 may generate a model related to artificial intelligence by performing a calculation related to artificial intelligence which is difficult or time-consuming, and provide related information for the electronic device 100.

For example, the information providing system 200 may generate, through an artificial intelligence operation, answer information, which a chatbot is to answer in response to user question information inputted from the electronic device 100, and provide the generated answer information for the electronic device 100. Further, the information providing system 200 may provide a previously learned question-answer model to the electronic device 100.

The network 300 may include, for example, a 5G mobile communication network, a local area network, and the Internet, and provide a communication environment to devices in a wired or wireless manner.

FIG. 2 is a block diagram illustrating an electronic apparatus according to an embodiment of the present disclosure.

The electronic device 100 may include a transceiver 110, an input interface 120, an output interface 140, a memory 150 and a processor 190. The components shown in FIG. 2 are not essential to implement the electronic device 100, and thus the electronic device 100 described in the specification may include more or less components than those listed above.

The transceiver 110 may include a wired or wireless communication module capable of communicating with the information providing system 200.

For example, the transceiver 110 may be equipped with a module for Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, and Near Field Communication (NFC).

According to an embodiment of the present disclosure, the processor 190 may transmit predetermined question information to the information providing system 200 through the transceiver 110, and receive answer information of a respondent (such as a chatbot) corresponding to the transmitted question information.

The input interface 120 may include a camera 121 configured to receive an image signal, a microphone 123 configured to receive an audio signal and an information receiver 125 configured to receive information from a user. The camera 121 or the microphone 123 may serve as a sensor, and a signal acquired from the camera 121 or the microphone 123 may be sensing data or sensor information.

The information receiver 125 may be used as a separate input means from the camera 121 and the microphone 123 but may include all input means of the electronic device 100 including the camera 121 and the microphone 123 according to an implemented embodiment of the present disclosure. The information receiver 125 may include various components configured to receive information. For example, the information transceiver 125 may receive information inputted from a touch screen of a display 141 and receive text information inputted from a keypad of the touch screen.

The input interface 120 may obtain, for example, learning data for model learning and input data used when output is obtained using a learning model. The input interface 120 may obtain raw input data. In this case, the processor 190 may extract an input feature by preprocessing the input data.

The output interface 140 may generate an output related to, for example, visual, auditory, and tactile sensations, and may include the display 141 and an optical output unit configured to output visual information, a speaker 143 configured to output auditory information and a haptic module configured to output tactile information. The display 141 may include a touch screen.

The memory 150 may store data for supporting various functions of the electronic device 100. The memory 150 may store a plurality of application programs (or applications) configured to be operated in the electronic device 100, data for the operation of the electronic device 100 and program commands.

The memory 150 may store a question-answer model 151. The question-answer model 151, which is a previously learned model, may be learned in the electronic device 100 and/or the information providing system 100 and then be stored in the memory 150.

The question-answer model according to an embodiment of the present disclosure may not be limited only to an artificial intelligence model, but may include a model required to interpret a natural language, a database configured to store extensive answer information for answering question information, and a model configured to select the answer information.

The memory 150 may store information on a topic associated with a user. The memory 150 may store, as information on the topic, information on a topic related to a product that the user purchased and information on a personal topic. The memory 150 may store event information related to each topic. The memory 150 may store an event list associated with each topic, a past history of at least one event included in the corresponding event list, and a schedule.

Additionally, the electronic device 100 may further include one or more sensors (not shown).

The sensor may acquire at least one of internal information, surrounding environment information of the electronic device 100, or user information.

Here, the sensor may include, for example, a satellite-based location sensor, a distance detection sensor, an illumination sensor, an acceleration sensor, a magnetic sensor, a gyroscope sensor, an inertial sensor, an RGB sensor, an infrared (IR) sensor, a finger scan sensor, an ultrasonic sensor, an optical sensor, a microphone, a light detection and ranging (LiDAR) sensor, a barometer sensor, or a radar sensor.

The processor 190, which is a module configured to control the components of the electronic device 100, may include one or more processors.

The processor 190 may refer to a hardware-embedded data processing device having a physically structured circuit to execute functions represented as instructions or codes included in a program. Examples of the data processing device built in a hardware include, but are not limited to, processing devices such as a microprocessor, a central processing unit (CPU), a processor core, a multiprocessor, an application-specific integrated circuit (ASIC), and a field programmable gate array (FPGA).

The processor 190 is coupled to the memory 150. Here, to be ‘coupled’ means that there is a physical/logical path that facilitates a transmitting and receiving of a control signal and data.

The processor 190 being configured to perform a kind of operation means that the processor 190 is set to perform a corresponding operation by executing a series of program instructions stored in the memory 150.

The processor 190 may determine a predicted interest index of the user regarding the corresponding topic based on the event information on the topic associated with the user, determine a topic to be used in conversation with the user based on the determined predicted interest index, and generate a question to be provided to the user in the conversation with the user based on the event information on the determined topic.

The processor 190 may be further configured to determine a predicted interest index of the user regarding the corresponding topic based on a past history of the event on the topic.

The processor 190 may be further configured to determine a topic having the highest predicted interest index as the topic to be used in the conversation with the user.

The processor 190 may be further configured to generate a question to be provided to the user in the conversation with the user when the predicted interest index is higher than a predetermined threshold value. The processor 190 may be further configured to provide the generated question as a conclusion to the conversation with the user. The processor 190 may be further configured to update the predicted interest index of the user based on feedback of the user with respect to the generated question.

The electronic device 100 may provide an answer to the question of the user.

For example, the processor 190 may acquire the question of the user through the input interface 120 and generate an answer by using the question-answer model stored in the memory 150. The generated answer may be provided for the user through the output interface 130.

The electronic device 100 may provide an additional question to the user in addition to the answer to the question of the user.

For example, the processor 190 may generate an additional question based on the predicted interest index of the user on the topic associated with the user. For this operation, the processor 190 may determine a predicted interest index of each topic based on the event information on the stored topic, determine a topic for the additional question based on the determined predicted interest index, and generate the additional question according to the determined topic.

Hereinafter, a method for operating the electronic device 100 according to an embodiment of the present disclosure will be described with reference to FIG. 3.

FIG. 3 is a flow diagram illustrating a method for operating an electronic apparatus according to an embodiment of the present disclosure.

The method for operating an electronic apparatus according to an embodiment of the present disclosure may include determining a predicted interest index of a user on a topic based on event information on the topic associated with the user (S10), determining a topic to be used in conversation with the user based on the predicted interest index (S20), and generating a question to be provided to the user in the conversation with the user based on the event information on the determined topic (S30).

In S10, the electronic device 100 may determine a predicted interest index of a user on a topic based on event information on the topic associated with the user.

The topic associated with the user means a topic related to the user. The topic associated with the user according to an embodiment of the present disclosure may include information on products that the user purchased or is using. For example, in the case in which the user purchases a washing machine, information on the washing machine constitutes one topic. According to an embodiment of the present disclosure, the topic associated with the user may include personal information. For example, the birthday of the user constitutes one topic. The event on the topic means a past event that occurs with respect to the topic. According to an embodiment of the present disclosure, the event on the topic may include an event that occurs most recently with respect to the topic. For example, in the case in which the user repairs the washing machine, the event on the topic regarding the ‘washing machine’ is a ‘repair,’ and the event information on the washing machine may include a date when the washing machine is repaired, a repair history, a person in charge of the repair, and information on costs.

The predicted interest index represents a predictive value of the interest of the user in the topic.

The memory of the electronic device 100 may store information on the topic associated with the user. The information on the topic includes event information on the topic.

In S10, the processor 190 may determine a predicted interest index of a user on a topic based on event information on the topic associated with the user which is stored in the memory 150. For example, the processor 190 may determine a predicted interest index of each user on multiple topics stored in the memory 150.

According to an embodiment of the present disclosure, the processor 190 may determine a predicted interest index based on a past history of the event associated with the user. Here, the past history may include a date when a past event occurred. For example, in the case in which the user purchased an air conditioner one year ago, the past event is the installation of the air conditioner and the date when the event occurred is a year ago.

In this case, the processor 190 may determine a predicted interest index on the topic depending on the time elapsed from the date when the past event occurred up to the present date. For example, the processor 190 may give a relatively higher predicted interest index to a topic that has an event in which a prolonged amount of time has elapsed from the date when the past event occurred.

According to an embodiment of the present disclosure, the processor 190 may determine a predicted interest index based on a schedule of the event on the topic associated with the user. For example, the event may be a personal schedule such as a birthday of the user.

In this case, the processor 190 may determine a predicted interest index on the topic depending on the extent to which the schedule of the event is imminent. For example, the processor 190 may give a relatively higher predicted interest index to a topic that has an event in which the schedule of the event is more imminent.

In S20, the electronic device 100 may determine a topic to be used in the conversation with the user based on the predicted interest index determined in S10.

The processor 190 may determine a topic to be used in the conversation with the user based on the predicted interest index determined in S10 from the topics associated with the user stored in the memory 150.

According to an embodiment of the present disclosure, the processor 190 may determine a topic having the highest predicted interest index determined in S10 as the topic to be used in the conversation with the user. In the case in which predicted interest indices are the same, the processor 190 may consider a topic related to product information as a priority over a topic related to personal information.

In S30, the electronic device 100 may generate a question to be provided to the user in the conversation with the user based on the event information on the topic determined in S20.

In S30, the processor 190 may generate a question to be provided to the user in the conversation with the user based on the event information on the topic determined in S20.

In S30, the processor 190 may generate a question to be provided to the user based on the event information on the topic included in the information on the topic stored in the memory 150. Here, the event information on the topic may include event information derived from the past event and event information that occurred in the past.

For example, when the topic determined in S20 as a topic related to a product is an air conditioner, and the event that occurred in the past is the installation of the air conditioner one year ago, an event derived from the past event may be the replacement of filters.

In S30, the processor 190 may generate a question to be provided to the user by using the question-answer model stored in the memory 150. According to an embodiment of the present disclosure, the electronic device 100 may provide the question generated in S30 as a conclusion to the conversation with the user. That is, the electronic device 100 may additionally provide the question generated in S30 for the user in response to the question of the user.

In addition, the method for operating an electronic apparatus according to an embodiment of the present disclosure may further include updating the predicted interest index of the user on the topic determined in S20 based on feedback of the user with respect to the question generated in S30. For example, the feedback of the user may increase the predicted interest index by a predetermined value depending on the degree of positivity.

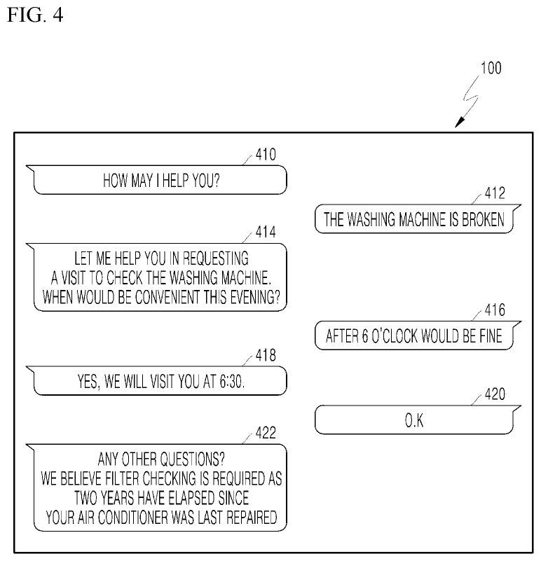

FIG. 4 is a diagram illustrating the method for operating an electronic apparatus according to an embodiment of the present disclosure.

The electronic device 100 may store a service providing scenario in the memory 150. The service providing scenario, as a conversation scenario with the user, means that the electronic device 100 defines the content of text to be generated subsequently in each phase depending on the context in the conversation. That is, FIG. 4 illustrates the display 141 of the electronic device 100 during the conversation with the user according to the service providing scenario.

The electronic device 100 responds to a service request of the user as a first sentence 410. For example, the first sentence 410 may include an expression to inquire to the user as to what the specific inquiry is (for example, ‘How may I help you?’) while informing that the user inquiry is ready to be processed.

The user who checks the first sentence 410 questions the user inquiry as a second sentence 412. For example, suppose that the user inquires that ‘the washing machine is broken.’

The electronic device 100 that receives the second sentence 412 generates an answer to the user inquiry. For example, the electronic device 100 may provide the user with a third sentence 414 for providing information to inform that it is necessary to check the washing machine and determining a check schedule according to the service scenario stored in the memory 150.

The electronic device 100 that receives a fourth sentence 416, which is an answer of the user to the third sentence 414, may answer as a fifth sentence 418 by checking the available visit schedule of a person in charge of repairing the washing machine (for example, ‘six thirty’) from ‘after six o'clock’ included in the fourth sentence 416.

The electronic device 100 that receives a sixth sentence 420, which is feedback from the user regarding the visit schedule included in the fifth sentence 418, may generate a seventh sentence 422 that includes an additional question. For example, the electronic device 100 may generate an additional question to be provided for the user based on the predicted interest index of the user according to the aforementioned operation method of the electronic device 100 with reference to FIG. 3.

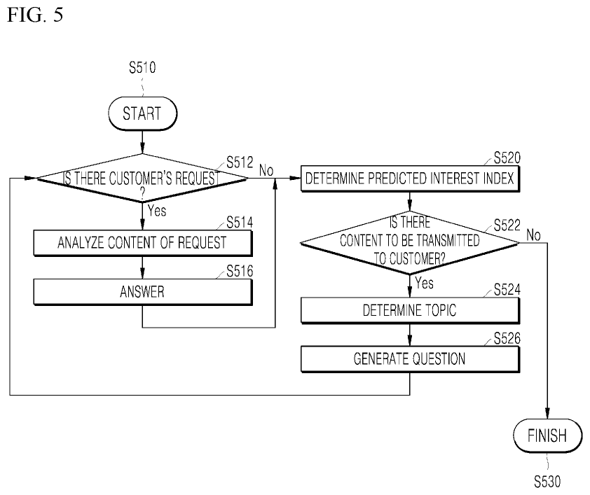

FIG. 5 is a flow diagram illustrating the method for operating an electronic apparatus according to an embodiment of the present disclosure.

In S510, the electronic 100 receives a service request of the user. For example, the user may be a customer who purchased a product, and a service request of the user may be an after-service request to the purchased product.

In S510, the electronic device 100 may generate a sentence to inform that the conversation with the user is available and provide the user with the generated sentence. For example, the electronic device 100 may provide the first sentence 410 to the user with reference to FIG. 4.

In S512, the electronic device 100 waits to receive a request from a customer.

When the electronic device 100 receives the customer request in S512, the electronic device 100 analyzes the content of the customer request in S514. For example, referring to FIG. 4, when the electronic device 100 receives the second sentence 412 which is a customer request, the electronic device 100 analyzes the content of the second sentence 412 in S514.

In S516, the electronic device 100 generates and provides an answer based on the content analyzed in S514. For example, the electronic device 100 may generate and provide the third sentence 414 with reference to FIG. 4.

Subsequently, when the electronic device 100 receives the customer request, the electronic device 100 may repeatedly perform S514 and S516. For example, referring to FIG. 4, the electronic device 100 may receive the fourth sentence 416 from the customer, and generate and provide the fifth sentence 418 in response to the fourth sentence 416.

When there is no customer request in S512, the electronic device 100 may generate an additional question based on the predicted interest index according to S520 to S526.

In S520, the electronic device 100 may determine a predicted interest index of the user on the topic based on the event information on the topic associated with the user. S520 corresponds to S10 with reference to FIG. 3.

In S522, the electronic device 100 may determine whether there is any content to be transmitted to the user based on the predicted interest index determined in S520.

For example, when there is a topic in which the predicted interest index is higher than a threshold value, the electronic device 100 may determine that there is content to be transmitted to the user and perform S526. When there is no topic in which the predicted interest index is higher than a threshold value, the electronic device 100 may determine that there is no content to be transmitted to the user and perform S530 to finish the conversation with the user.

In S524, the electronic device 100 may determine a topic to be used in the conversation with the user based on the predicted interest index determined in S520 when the electronic device 100 determines that there is content to be transmitted to the user in S522. S524 corresponds to S20 with reference to FIG. 3.

In S526, the electronic device 100 generates a question to be provided to the user in the conversation with the user based on the event information on the topic determined in S524. S526 corresponds to S30 with reference to FIG. 3.

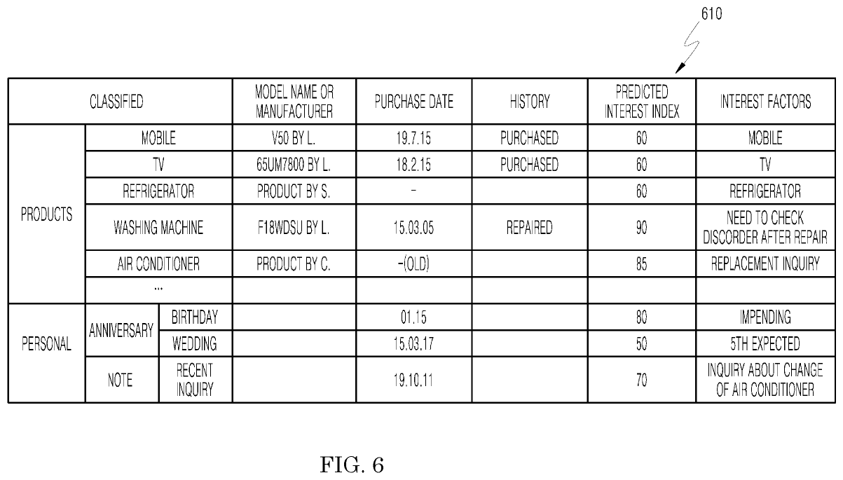

FIG. 6 is a table illustrating information on an exemplary topic.

As mentioned above, the electronic device 100 may store the information on the topic in the memory 150. Table 610 shown in FIG. 6 illustrates information on an exemplary topic.

The information on the topic may include information on a topic related to products that the user purchased and information on a personal topic. In Table 610, the topic related to products includes, for example, a refrigerator, a washing machine, and an air conditioner, and the personal topic includes, for example, an anniversary.

For example, the information on the topic related to products may include product information such as a model name or a manufacturer, a purchase date, and a history. The personal topic may include anniversary dates. Additionally, the information on the topic may include interest factors and predicted interest indexes of the user on the topic.

The information on the topic may include event information associated with the topic. The event information associated with the topic may include an event list associated with the topic, a past history of at least one event included in the corresponding event list, and a schedule.

For example, the event information associated with the washing machine may include a first event (for example, a purchase of the washing machine) and a second event (for example, a repair of the washing machine). Here, the first event may include a past history (purchase and purchase date) and a schedule (examining the purchase satisfaction). The second event may include a past history (repair and repair date) and a schedule (checking whether there are any abnormalities after the repair).

As described above, the electronic device 100 may generate an additional question to be provided to the user based on the predicted interest index on the topic stored in the memory 150. For example, since the washing machine among the topics shown in Table 610 needs to be checked as to whether there are any abnormalities after the repair, and the washing machine has the highest predicted interest index, the electronic device 100 may generate a question to ask about the operation state after the repair of the washing machine.

The example embodiments described above may be implemented through computer programs executable through various components on a computer, and such computer programs may be recorded on computer-readable media. In this case, examples of the computer-readable media may include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program instructions, such as ROM, RAM, and flash memory devices.

The computer programs may be those specially designed and constructed for the purposes of the present disclosure or they may be of the kind well known and available to those skilled in the computer software arts. Examples of program code included both machine codes, such as produced by a complier, and higher-level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numerical ranges include every individual value between the minimum and maximum values of the numerical ranges.

The order of individual steps in process claims according to the present disclosure does not imply that the steps must be performed in this order; rather, the steps may be performed in any suitable order, unless expressly indicated otherwise. In other words, the present disclosure is not necessarily limited to the order in which the individual steps are recited. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof.

It should be apparent to those skilled in the art that various substitutions, changes and modifications which are not exemplified herein but are still within the spirit and scope of the present disclosure may be made.

While the specific exemplary embodiments of the present disclosure have been described above and illustrated, it will be understood by those skilled in the art that the present disclosure is not limited to the described exemplary embodiments, and various modifications and alterations may be made without departing from the spirit and the scope of the present disclosure. Therefore, the scope of the present disclosure is not limited to the above-described exemplary embodiments, but shall be defined by the technical thought as recited in the following claims.

What is claimed is:

1. An electronic apparatus, comprising:
a memory configured to store information on a topic associated with a user; and
a processor coupled to the memory,
wherein the processor is configured to:
determine a predicted interest index of the user on the topic based on event information of the topic;
determine a topic to be used in conversation with the user based on the predicted interest index; and
generate a question to be provided to the user in conversation with the user based on the event information of the determined topic.

2. The electronic apparatus according to claim 1, wherein the processor is further configured to determine the predicted interest index based on a planned schedule of an event on the topic.

3. The electronic apparatus according to claim 1, wherein the processor is further configured to determine the predicted interest index based on a past history of the event on the topic.

4. The electronic apparatus according to claim 1, wherein the processor is further configured to determine a topic having the highest predicted interest index as the topic to be used in the conversation with the user.

5. The electronic apparatus according to claim 1, wherein the processor is further configured to generate the question when the predicted interest index is equal to or higher than a predetermined threshold value.

6. The electronic apparatus according to claim 1, wherein the processor is further configured to provide the question as a conclusion of the conversation with the user.

7. The electronic apparatus according to claim 1, wherein the processor is further configured to update the predicted interest index based on feedback of the user with respect to the question.

8. The electronic apparatus according to claim 1, wherein the information on the topic stored in the memory comprises information on a topic related to a product that the user has purchased and information on a personal topic.

9. The electronic apparatus according to claim 1, wherein the event information associated with the topic comprises an event list associated with the topic, a past history of at least one event comprised in the event list, and a planned schedule.

10. A method for operating an electronic apparatus, the method comprising:
determining a predicted interest index of a user on a topic based on event information on the topic associated with the user;
determining a topic to be used in conversation with the user based on the predicted interest index; and
generating a question to be provided to the user in the conversation with the user based on the event information on the determined topic.

11. The method according to claim 10, wherein the determining a predicted interest index of the user comprises determining the predicted interest index based on a schedule of an event on the topic.

12. The method according to claim 10, wherein the determining a predicted interest index of the user comprises determining the predicted interest index based on a past history of the event on the topic.

13. The method according to claim 10, wherein the determining a topic comprises determining a topic having the highest predicted interest index as the topic to be used in the conversation with the user.

14. The method according to claim 10, further comprising providing the question as a conclusion to the conversation with the user.

15. The method according to claim 10, further comprising updating the predicted interest index based on feedback of the user with respect to the question.
